(19) United States
(12) Patent Application Publication
(10) Pub. No.: US 2024/0191081 A1
(43) Pub. Date: Jun. 13, 2024

(54) Carbon Blacks Based on Renewable Carbon Black Feedstocks

(71) Applicant: Orion Engineered Carbons IP GmbH & Co. KG, Monheim (DE)

(72) Inventors: Patrick Post, Brühl (DE); Arndt-Peter Schinkel, Lahnstein (DE); Thomas Weprich, Hainburg (DE); Gerd Tauber, Seligenstadt (DE); Guido Waidmann, Erftstadt (DE)

(21) Appl. No.: 18/286,594

(22) PCT Filed: Mar. 30, 2022
(86) PCT No.: PCT/EP2022/058457

§ 371 Date: Oct. 12, 2023

(30) Foreign Application Priority Data
Apr. 13, 2021 (EP) EP21168081

(51) Int. Cl. C09C 1/50; C08K 3/04; C09D 7/61; C09D 11/037

(52) U.S. Cl. CPC C09C 1/50; C08K 3/04; C09D 7/61; C09D 11/037; C01P 2006/12; C01P 2006/19; C01P 2006/80; C08K 2201/006

(57) ABSTRACT

The present invention relates to a carbon black and to a process to produce such carbon black as well as uses of such carbon black. The present invention further relates to compositions including such carbon black and the use of such compositions.

### CROSS-REFERENCE TO RELATED APPLICATIONS

This application is the United States national phase of International Application No. PCT/EP2022/058457 filed Mar. 30, 2022, and claims priority to European Patent Application No. EP21168081 filed Apr. 13, 2021, the disclosures of which are hereby incorporated by reference in their entireties.

### BACKGROUND OF THE INVENTION

### Field of the Invention

The present invention relates to a carbon black and to a process to produce such carbon black as well as uses of such carbon black. The present invention further relates to compositions comprising such carbon black and uses of such compositions.

### Description of Related Art

Carbon blacks are used in many applications, e.g., as fillers or pigments, because of their unique properties. However, carbon blacks are conventionally produced using fossil raw materials, such as coal and crude oil. Fossil raw materials are limited and they are depleting at a fast rate. Moreover, fossil raw materials mainly have a negative impact on the environment, as their extraction and transport can have a high environmental impact. For example, oil spills have occurred in the past leading to pollution of water bodies and death of aquatic animals including those living offshore. In addition, the combustion of fossil raw materials and thus production of carbon dioxide is known to be one of the primary factors responsible for global warming.

It is desirable to avoid the disadvantages derived from the use of fossil raw materials. Renewable materials used as feedstock for the production of carbon blacks is more environmentally friendly. Renewable feedstock, such as plant-based renewable feedstock, are carbon dioxide neutral, since the combustion of plant-based feedstock only releases as much carbon dioxide into the atmosphere as was absorbed by the plants during their life cycle. The use of renewable feedstock contributes to the preservation of limited fossil resources and it creates opportunities for the realization of a circular economy.

Depending on the various applications, it is desirable that carbon black materials produced from renewable feedstocks exhibit certain properties comparable to known carbon blacks. With regard to certain applications, e.g., specifically in printing or coating applications, low oil absorption numbers (OAN) are desirable. In addition, with regard to the use of carbon black in articles intended to come into contact with food or the skin, such as in food and drinking water applications, as well as toys, low concentrations of polyaromatic hydrocarbons (PAHs) as well as low levels of toluene and sulfur extractables contents are desirable.

According to Commission Regulation (EU) No. 10/2011, Commission Regulation (EU) No. 1272/2013, Swiss Ordinance 817.023.21, the French AVIS Seance of Nov. 7, 1995, or the German Ink Ordinance, low concentrations of polyaromatic hydrocarbons (PAHs) and low levels of toluene and cyclohexane extractable contents are required for the use of carbon black in food packaging. PAHs in particular are considered harmful compounds (Sudip K. Samanta, Om V. Singh and Rakesh K. Jain, “Polycylic aromatic hydrocarbons: environmental pollution and bioremediation,” Trends in Biotechnology, Vol. 20, No. 6, 2002, pp. 243-248).

In view of the increasing problem of occurring packaging waste, it is also desirable that the carbon blacks used for, e.g., packaging application, such as food packaging, and coating application comply with DIN EN 13432 for recyclable packaging by composting and biodegradation.

It is therefore an objective of the present invention to provide a carbon black which is environmentally friendly and has comparable properties to known and established carbon blacks. It is further the objective of the present invention to provide a carbon black having low oil absorption numbers (OAN), which is specifically suitable for the application in printing or coating applications. In addition, it is an objective of the present invention to provide a carbon black having low concentrations of polyaromatic hydrocarbons (PAHs) as well as low levels of toluene and sulfur extractables contents, which is necessary for the use of carbon black materials in toys as well as articles intended to come into contact with food or the skin.

### SUMMARY OF THE INVENTION

It has surprisingly been shown, that the objective can be solved by the carbon black as disclosed herein. Specific or preferred variants of the carbon black of the present invention are set forth as disclosed herein.

The following clauses summarize some aspects of the present invention.

A first aspect of the present invention relates to a carbon black obtained from a carbon black feedstock comprising a renewable carbon black feedstock, wherein the carbon black has an oil absorption number (OAN) measured according to ASTM D2414-19 of equal to or less than 80 mL/100 g.

A second aspect of the present invention relates to the carbon black according to the first aspect, wherein the renewable carbon feedstock comprises a plant-based feedstock, preferably a non-edible plant-based feedstock or a waste plant-based feedstock.

A third aspect of the present invention relates to the carbon black according to any one of the preceding aspects, wherein the renewable carbon black feedstock comprises solid components and/or liquid components, preferably liquid components.

A fourth aspect of the present invention relates to the carbon black according to any one of the preceding aspects, wherein the renewable carbon black feedstock comprises woods, grass, cellulose, hemicellulose, lignin, waste material comprising natural rubber and/or synthetic rubber obtained from a renewable source material, black liquor, tall oil, rubber seed oil, tobacco seed oil, castor oil, pongamia oil, crambe oil, neem oil, apricot kernel oil, rice bran oil, cashew nut shell oil, cyperus esculentus oil, cooking oil, distillation residues from biodiesel plants or a mixture or combination of any of the foregoing.

A fifth aspect of the present invention relates to the carbon black according to any one of the preceding aspects, wherein the renewable carbon black feedstock comprises tall oil, preferably tall oil pitch.

A sixth aspect of the present invention relates to the carbon black according to the fourth aspect, wherein the cooking oil comprises rice bran oil, rapeseed oil, linseed oil, palm oil, coconut oil, canola oil, soybean oil, sunflower oil, cotton seed oil, pine seed oil, olive oil, corn oil, grape seed oil, safflower oil, acai palm oil, jambú oil, sesame oil, chia seed oil, hemp oil, perilla oil, peanut oil, stillingia oil, cashew nut oil, brazil nut oil, macadamia nut oil, walnut oil, almond oil, hazel nut oil, beechnut oil, candlenut oil, chestnut oil or a mixture or combination of any of the foregoing, and wherein the cooking oil preferably is used cooking oil.

A seventh aspect of the present invention relates to the carbon black according to any one of the preceding aspects, wherein the carbon black feedstock comprises the renewable carbon black feedstock in an amount greater than or equal to 10 wt.-, preferably greater than or equal to 15 wt.-%, particularly preferably greater than or equal to 25 wt.-%, more preferably greater than or equal to 50 wt.-%, even more preferably greater than or equal to 85 wt.-%, most preferably greater than or equal to 99 wt.-%, the weight percent being based on the total weight of the carbon black feedstock.

An eighth aspect of the present invention relates to the carbon black according to any one of the preceding aspects, wherein the carbon black feedstock consists of the renewable carbon black feedstock.

A ninth aspect of the present invention relates to the carbon black according to any one of the preceding aspects, wherein the carbon black has a pMC (percent of modern carbon) of 5% or more determined according to ASTM D6866-20 Methode B (AMS), preferably of 10% or more, further preferably of 15% or more, more preferably of 50% or more, even more preferably of 85% or more, most preferably of 90% or more.

A tenth aspect of the present invention relates to the carbon black according to any one of the preceding aspects, wherein the carbon black has a pMC (percent of modern carbon) of 100%, determined according to ASTM D6866-20 Methode B (AMS).

An eleventh aspect of the present invention relates to the carbon black according to any one of the preceding aspects, wherein the carbon black has an oil absorption number (OAN) measured according to ASTM D2414-19 of equal to or less than 70 mL/100 g, preferably of equal to or less than 60 mL/100 g, further preferably of equal to or less than 50 mL/100 g, more preferably of equal to or less than 45 mL/100 g, even more preferably of equal to or less than 40 mL/100 g, most preferably of equal to or less than 37 mL/100 g.

A twelfth aspect of the present invention relates to the carbon black according to any one of the preceding aspects, wherein the carbon black has an oil absorption number (OAN) measured according to ASTM D2414-19 in a range of from 19 to 80 mL/100 g, preferably from 19 to 70 mL/100 g, further preferably from 23 to 60 mL/100 g, more preferably from 23 to 50 mL/100 g, even more preferably from 25 to 40 mL/100 g, most preferably from 25 to 37 mL/100 g.

A thirteenth aspect of the present invention relates to the carbon black according to any one of the preceding aspects, wherein the carbon black has a BET surface area determined according to ASTM D6556-19a in a range of from 15 to 400 m²/g, preferably from 30 to 350 m²/g, further preferably from 40 to 300 m²/g, more preferably from 50 to 250 m²/g, even more preferably from 60 to 200 m²/g, most preferably from 65 to 180 m2/g.

A fourteenth aspect of the present invention relates to the carbon black according to any one of the preceding aspects, wherein the carbon black has a statistical thickness surface area (STSA) determined according to ASTM D6556-19a in a range of from 15 to 300 m²/g, preferably from 30 to 250 m²/g, more preferably from 50 to 200 m²/g, even more preferably from 60 to 180 m²/g, most preferably from 65 to 150 m²/g.

A fifteenth aspect of the present invention relates to the carbon black according to any one of the preceding aspects, wherein the carbon black has a tint strength determined according to ASTM D3265-19b in a range of from 20 to 200%, preferably from 60 to 150%, more preferably from 80 to 120%, even more preferably from 90 to 110%.

A sixteenth aspect of the present invention relates to the carbon black according to any one of the preceding aspects, wherein the carbon black has a transmittance value at 425 nm determined according to ASTM D1618-18 in a range of from 50 to 100%, preferably from 70 to 100%, more preferably from 80 to 100%, even more preferably from 90 to 100%, most preferably from 95 to 100%.

A seventeenth aspect of the present invention relates to the carbon black according to any one of the preceding aspects, wherein the carbon black has a content of polycyclic aromatic hydrocarbons measured according to FDA methods No. 63 (22 FDA PAH) of less than 10 ppm, preferably less than 5 ppm, particularly less than 1 ppm, more preferably less than 0.5 ppm, even more preferably less than 0.4 ppm, most preferably less than 0.2 ppm.

An eighteenth aspect of the present invention relates to the carbon black according to any one of the preceding aspects, wherein the carbon black has a content of polycyclic aromatic hydrocarbons measured according to FDA method No. 63 (22 FDA PAH) in a range of from 0.001 to 10 ppm, preferably from 0.001 to 5 ppm, particularly preferably from 0.001 to 1 pm, more preferably from 0.001 to 0.5 ppm, even more preferably from 0.001 to 0.4 ppm, most preferably of 0.001 to 0.2 ppm.

A nineteenth aspect of the present invention relates to the carbon black according to any one of the preceding aspects, wherein the carbon black has a content of toluene-soluble constituents in a range of from 0.01% to 0.20%, preferably from 0.02% to 0.10%.

A twentieth aspect of the present invention relates to the carbon black according to any one of the preceding aspects, wherein the carbon black has a sulfur content determined according to ASTM D1619-20 in a range of from 0 to 2.5%, preferably from 0 to 2.0%, more preferably from 0 to 1.5%.

A twenty-first aspect of the present invention relates to the carbon black according to any one of the preceding aspects, wherein the carbon black is a plasma black, gas black, channel black, thermal black, lamp black or furnace black.

A twenty-second aspect of the present invention relates to the carbon black according to any one of the preceding aspects, wherein the carbon black is a furnace black.

A twenty-third aspect of the present invention relates to the carbon black according to any one of the preceding aspects, wherein the carbon black is oxidized and/or functionalized.

A twenty-fourth aspect of the present invention relates to a process for producing the carbon black according to any one of the preceding aspects through thermal oxidative pyrolysis or cleavage of a carbon black feedstock in a reactor, the process comprising feeding an O₂-containing gas stream and a fuel stream comprising combustible material to the reactor; subjecting the combustible material to combustion in a combustion step to provide a combustion gas stream, wherein the O2-containing gas stream and the fuel stream comprising combustible material are provided for the combustion step in amounts corresponding to a k factor in the range of from 0.5 to 1.0, wherein the k factor is the ratio of O₂ theoretically necessary for stoichiometric combustion of all combustible material in the combustion step to the total O₂ provided for the combustion step; contacting the carbon black feedstock with the combustion gas stream in a reaction step to form carbon black; and terminating the carbon black formation reaction in a terminating step; wherein the carbon black feedstock comprises a renewable carbon black feedstock.

A twenty-fifth aspect of the present invention relates to the process according to the twenty-fourth aspect, wherein the k factor is in the range of from 0.6 to 1.0, preferably from 0.7 to 1.0, more preferably from 0.75 to 1.0, even more preferably from 0.8 to 1.0.

A twenty-sixth aspect of the present invention relates to the process according to any one of the twenty-fourth or twenty-fifth aspects, wherein the renewable carbon black feedstock is as described in any one of the second to eighth aspects.

A twenty-seventh aspect of the present invention relates to the process according to any one of the twenty-fourth to twenty-sixth aspects, wherein the carbon black formation is terminated when an acetylene amount of less than 0.8 mol.-%, based on the total dry tail gas stream, is reached, preferably of less than 0.6 mol.-%, more preferably of less than 0.5 mol.-%, even more preferably of less than 0.2 mol.-%.

A twenty-eighth aspect of the present invention relates to the process according to any one of the twenty-fourth to twenty-seventh aspects, wherein the reaction is carried out in a furnace-black reactor having along a reactor axis a combustion zone, a reaction zone and a termination zone, including producing a combustion gas stream in the combustion zone, and passing the combustion gas from the combustion zone through the reaction zone into the terminating zone, injecting the carbon black feedstock into the combustion gas in the reaction zone to form carbon black, and terminating carbon black formation in the termination zone by lowering the temperature by quenching and/or by using a quench boiler.

A twenty-ninth aspect of the present invention relates to a use of the carbon black according to any one of the first to twenty-third aspects as reinforcing filler or additives, UV stabilizer, conductive carbon black or pigment.

A thirtieth aspect of the present invention relates to a use of the carbon black according to any one of the first to twenty-third aspects in rubber, plastics, inks such as printing inks, inkjet inks or other inks, toners, lacquers, coatings, papers or black matrix applications.

A thirty-first aspect of the present invention relates to a rubber composition, comprising at least one rubber material and at least one carbon black according to any one of the first to twenty-third aspects.

A thirty-second aspect of the present invention relates to the rubber composition according to the thirty-first aspect, wherein the at least one rubber material comprises natural rubber, styrene-butadiene rubber such as emulsion-styrene-butadiene rubber (ESBR) and solution-styrene-butadiene rubber (SSBR), polybutadiene, polyisoprene, ethylene-propylene-diene rubber (EPDM), ethylene-propylene rubber (EPM), butyl rubber, halogenated butyl rubber, chlorinated polyethylene, chlorosulfonated polyethylene, acrylonitrile-butadiene rubber, hydrogenated acrylonitrile-butadiene rubber, polychloroprene, acrylate rubber, ethylene-vinylacetate rubber, ethylene-acrylic rubber, epichlorohydrin rubber, silicone rubber, fluorosilicone rubber, fluorocarbon rubber or a mixture or combination of any of the foregoing.

A thirty-third aspect of the present invention relates to the rubber composition according to the thirty-first or thirty-second aspects, wherein the carbon black has at least one, preferably all of the following properties: (a) a STSA determined according to ASTM D6556-19a in a range of from 15 to 200 m²/g; (b) a transmittance value at 425 nm determined according to ASTM 1618-18 in a range of 80 to 100%.

A thirty-fourth aspect of the present invention relates to a plastic composition comprising at least one plastic material and at least one carbon black according to any one of the first to twenty-third aspects.

A thirty-fifth aspect of the present invention relates to the plastic composition according to the thirty-fourth aspect, wherein the at least one plastic material comprises a thermoplastic polymer, a thermosetting polymer, a thermoplastic elastomer, preferably low and high density polyethylene and polypropylene, polyvinyl chloride, melamine-formaldehyde resin, phenolic resin, epoxy resin, polyamide, polyester, polyoxymethylene, polymethyl methacrylate, polycarbonate, polystyrene, polyurethane, polyphenylene oxide, polysiloxane, polyacryloamide, polyaryletherketone, polysulfone, polyetherimide, acrylonitrile styrene acrylate or acrylonitrile butadiene styrene polymer and mixtures or co-polymers of any of the foregoing.

A thirty-sixth aspect of the present invention relates to the plastic composition according to the thirty-fourth or thirty-fifth aspects, wherein the carbon black has at least one, preferably two or more or all of the following properties: (a) an OAN determined according ASTM D2414-19 in a range of from 45 to 80 mL/100 g, preferably from 50 to 70 mL/100 g; (b) a STSA determined according to ASTM D6556-19a in a range of from 15 to 200 m²/g; (c) a tint strength determined according to ASTM D1618-18 in a range of from 20 to 160%, preferably from 20 to 150%; (d) a content of toluene-soluble constituents of less than 0.1%.

A thirty-seventh aspect of the present invention relates to an ink composition comprising a liquid carrier material and at least one carbon black according to any one of the first to twenty-third aspects.

A thirty-eighth aspect of the present invention relates to the ink composition according to the thirty-seventh aspect, wherein the carbon black has at least one, preferably all of the following properties: (a) an OAN measured according to ASTM D2414-19 in a range of from 19 to 50 mL/100 g, preferably from 23 to 45 mL/100 g, more preferably from 25 to 40 mL/100 g; (b) a STSA determined according to ASTM D6556-19a in a range of 60 to 150 m²/g.

A thirty-ninth aspect of the present invention relates to use of the ink composition according to the thirty-seventh or thirty-eighth aspects for printing and coating applications, preferably for print media and packaging, more preferably for food packaging.

A fortieth aspect of the present invention relates to a black matrix composition comprising at least a carbon black according to any one of the first to twenty-third aspects.

A forty-first aspect of the present invention relates to the black matrix composition according to the fortieth aspect, wherein the carbon black has at least one, preferably all of the following properties: (a) an OAN measured according to ASTM D2414-19 of less than 37 mL/100 g; (b) a STSA determined according to ASTM D6556-19a in a range of from 60 to 150 m²/g.

A forty-second aspect of the present invention relates black matrix composition according to the fortieth or forty-first aspects, wherein the carbon black is oxidized and/or functionalized.

A forty-third aspect of the present invention relates to a coating composition comprising at least one carbon black according to any one of the first to twenty-third aspects.

A forty-fourth aspect of the present invention relates to the coating composition according to the forty-third aspect, wherein the carbon black has at least one, preferably all of the following properties: (a) an OAN measured according to ASTM D2414-19 in a range of from 19 to 50 mL/100 g, preferably from 23 to 45 mL/100 g, more preferably from 25 to 40 mL/100 g; (b) a STSA determined according to ASTM D6556-19a in a range of 60 to 150 m²/g.

A forty-fifth aspect of the present invention relates to a use of the coating composition according to the forty-third or forty-fourth aspects for toys and articles intended for use in contact with food or skin.

### DESCRIPTION OF THE INVENTION

The present invention relates to a carbon black obtained from a carbon black feedstock comprising a renewable carbon black feedstock, wherein the carbon black has an oil absorption number (OAN) of equal to or less than 80 mL/100 g. The oil absorption number is measured according to ASTM D2414-19.

As used herein, the term “carbon black” relates to a material composed substantially, e.g., to more than 80 wt.%, or more than 90 wt.% or more than 95 wt.%, based on its total weight of carbon that is produced by thermal oxidative pyrolysis or cleavage of a carbon feedstock. Different industrial processes are known for the production of carbon blacks such as the furnace process, gas black process, acetylene black process, thermal black process or lamp black process. The production of carbon blacks is per se well known in the art and for example outlined in J.-B. Donnet et al., “Carbon Black: Science and Technology”, 2nd edition and will be further described below.

According to the present invention, the renewable carbon black feedstock can comprise a plant-based feedstock, preferably a non-edible plant-based feedstock and/or a waste plant-based feedstock. As used herein, the term “non-edible” refers to materials that are suitable for human consumption. The term “waste” refers to materials that are discarded or disposed of as unsuitable or no longer useful for the intended purpose, e.g., after use. With respect to edible oils, i.e., cooking oils, used cooking oils are considered waste.

The renewable carbon black feedstock may comprise solid components and/or liquid components. Preferably, the renewable carbon black feedstock may comprise liquid components.

The renewable carbon black feedstock preferably may comprise plant-based oils and more preferably non-edible plant-based oils and/or waste plant-based oils.

The renewable carbon black feedstock according to the present invention may comprise wood, grass, cellulose, hemicellulose, lignin, waste material comprising natural rubber and/or synthetic rubber obtained from a renewable source material, black liquor, tall oil, rubber seed oil, tobacco seed oil, castor oil, pongamia oil, crambe oil, neem oil, apricot kernel oil, rice bran oil, cashew nut shell oil, cyperus esculentus oil, cooking oil, distillation residues from biodiesel plants or a mixture or combination of any of the foregoing.

As used herein, the term “wood” refers to porous and fibrous structural tissue found in the stems and roots of trees and other woody plants. Suitable examples of wood include, but are not limited to, pine, spruce, larch, juniper, ash, hornbeam, birch, alder, beech, oak, pines, chestnut, mulberry or mixtures thereof. Suitable examples of grass include, but are not limited to, cereal grass, such as maize, wheat, rice, barley or millet; bamboos and grass of natural grassland and species cultivated in lawns and pasture. Suitable examples of lignin may include, but are not limited to, lignin removed by Kraft process and lignosulfonates. Waste materials comprising natural rubber and/or synthetic rubber obtained from a renewable source material may be tires, cable sheaths, tubes, conveyor belts, shoe soles, hoses or mixtures thereof. Natural rubber may be derived from rubber trees (Helvea brasiliensis), guayule, and dandelion. Synthetic rubber may include styrene-butadiene rubber such as emulsion-styrene-butadiene rubber (ESBR) and solution-styrene-butadiene rubber (SSBR), polybutadiene, polyisoprene, ethylene-propylene-diene rubber (EPDM), ethylene-propylene rubber (EPM), butyl rubber, halogenated butyl rubber, chlorinated polyethylene, chlorosulfonated polyethylene, acrylonitrile-butadiene rubber, hydrogenated acrylonitrile-butadiene rubber, polychloroprene, acrylate rubber, ethylene-vinylacetate rubber, ethylene-acrylic rubber, epichlorohydrin rubber, silicone rubber, fluorosilicone rubber, fluorocarbon rubber or a mixture or combinations of any of the foregoing. Synthetic rubber, such as polybutadiene, may be produced from alcohol obtained through fermentation of plant biomass. Suitable preparation of alcohol obtained through fermentation and preparation of polybutadiene from such alcohol is described in EP 2 868 697 A1.

As used herein, the term “cooking oil” refers to edible oils used in food preparation, such as in frying, baking and other types of cooking. According to the present invention, cooking oils may comprise rice bran oil, rapeseed oil, linseed oil, palm oil, coconut oil, canola oil, soybean oil, sunflower oil, cotton seed oil, pine seed oil, olive oil, corn oil, grape seed oil, safflower oil, acai palm oil, jambú oil, sesame oil, chia seed oil, hemp oil, perilla oil, peanut oil, stillingia oil, cashew nut oil, brazil nut oil, macadamia nut oil, walnut oil, almond oil, hazel nut oil, beechnut oil, candlenut oil, chestnut oil or a mixture or combination of any of the foregoing. The cooking oil of the present invention may be used cooking oil. As used herein, the term “used cooking oil” refers to oils originating from commercial or industrial food processing operations, such as restaurants, that have been used for food preparation, such as cooking or frying.

Solid components may be selected from, but are not limited to, wood, grass, cellulose, hemicellulose, lignin, waste material comprising natural rubber and/or synthetic rubber obtained from a renewable source material or a mixture or combination of any of the foregoing.

Liquid components may be selected from, but are not limited to, black liquor, tall oil, rubber seed oil, tobacco seed oil, castor oil, pongamia oil, crambe oil, neem oil, apricot kernel oil, rice bran oil, cashew nut shell oil, cyperus esculentus oil, cooking oil, distillation residues from biodiesel plants or a mixture or combination of any of the foregoing. Some oils may be solid at room temperature, e.g., at temperatures of 25° C., but liquid at elevated temperatures, such as temperatures above 25° C., e.g., temperatures in a range of 25 to 100° C. As used herein, the term “black liquor” refers to a by-product from the Kraft process which comes from the sulfate and soda processes of making cellulosic pulp.

Non-edible plant-based feedstock may comprise, but is not limited to, wood, cellulose, hemicellulose, lignin, black liquor, tall oil, rubber seed oil, tobacco seed oil, castor oil, pongamia oil, crambe oil, neem oil, apricot kernel oil, rice bran oil, cashew nut shell oil, cyperus esculentus oil, distillation residues from biodiesel plants, waste materials comprising natural rubber and/or synthetic rubber obtained from a renewable source material or a mixture or combination of any of the foregoing.

Waste plant-based feedstock may comprise, but is not limited to, waste material comprising natural rubber and/or synthetic rubber obtained from a renewable source material, used cooking oils or a mixture or combination of any of the foregoing.

According to the present invention, the carbon black feedstock may comprise tall oil. The terms “tall oil” and “crude tall oil” may be used interchangeably throughout this description unless otherwise stated. Tall oil is derived from the chemical pulping of woods. Typically, tall oil is a mixture comprising resin acids, fatty acids, sterols, alcohols and further alkyl hydrocarbon derivatives. Tall oil may be a natural unrefined product or a refined product. Refined tall oil may include tall oil fatty acid, tall oil fatty rosin, distilled tall oil and tall oil pitch. Tall oil can be distilled to obtain tall oil resin acids containing more than 10 wt.-% of resin acid content. Tall oil may also be refined to tall oil fatty acids, where the resin acid content is typically less than 10 wt.-%. Suitable examples of tall oil may include, but are not limited to, SYLFAT™ products, SYLVATAL™ products, SYLVABLEND™ products and SYLVAROS™ products, all available from Kraton Corporation (USA), as well as tall oil products, such as crude tall oils and Tall Oil 1, available from UCY Energy (Germany).

According to the present invention the carbon black feedstock may in particular comprise tall oil pitch. Tall oil pitch is obtained as a nonvolatile residue from refining by distillation of tall oil and may be mixed with fore-runs of tall oil refining. The yield of tall oil pitch in the refining process may range from about 15 to 50 wt.-%, depending for example on the quality and composition of the tall oil. Tall oil pitch typically comprises neutral substances, free acids including resin acids and fatty acids, fatty acid esters, bound and free sterols, and polymeric compounds. Additionally, metals, metal cations, inorganic and organic compounds including metal resinates and salts of fatty acids can be found in tall oil pitch. Said metal cations typically originate from wood and fertilizers. Suitable examples of tall oil pitch include, but are not limited to, SYLVABLEND™ products, such as SYLVABLEND FA7002, SYLVABLEND PF 40, SYLVABLEND PF 60 and SYLVABLEND SF75 all available from Kraton Corporation (USA) as well as Tall Oil 1, UCY-TOF40 and UCY-TOF60 all available from UCY Energy (Germany).

According to the present invention, the carbon black feedstock can be a mixture of renewable carbon black feedstock and conventional carbon black feedstock. Conventional carbon black feedstock may be aliphatic or aromatic, saturated or unsaturated hydrocarbons or mixtures thereof, coal tar distillates, residual oils which are produced during the catalytic cracking of petroleum fractions, residual oils which are produced during olefin production through cracking of naphta or gas oil, natural gas or a mixture or combination of any of the foregoing.

The carbon black feedstock of the present invention may comprise the renewable carbon black feedstock in an amount greater than or equal to 10 wt.% based on the total weight of the carbon black feedstock. For example, the carbon black feedstock according to the present invention can comprise the renewable carbon black feedstock in an amount greater than or equal to 15 wt.%, or in an amount greater than or equal to 20 wt.%, or in an amount greater than or equal to 25 wt.%, or in an amount greater than or equal to 30 wt.%, or in an amount greater than or equal to 35 wt.%, or in an amount greater than or equal to 40 wt.%, or in an amount greater than or equal to 45 wt.%, or in an amount greater than or equal to 50 wt.%, or in an amount greater than or equal to 55 wt.%, or in an amount greater than or equal to 60 wt.%, or in an amount greater than or equal to 65 wt.%, or in an amount greater than or equal to 70 wt.%, or in an amount greater than or equal to 75 wt.%, or in an amount greater than or equal to 80 wt.%, or in an amount greater than or equal to 85 wt.%, or in an amount greater than or equal to 90 wt.%, or in an amount greater than or equal to 95 wt.%, the weight percentage being based on the total weight of the carbon black feedstock. The carbon black feedstock may comprise the renewable carbon black feedstock in an amount greater than or equal to 10 wt.-%, preferably greater than or equal to 15 wt.-%, particularly preferably greater than or equal to 25 wt.-%, more preferably greater than or equal to 50 wt.-%, even more preferably greater than or equal to 85 wt.-%, most preferably greater than or equal to 99 wt.-%, the weight percent being based on the total weight of the carbon black feedstock. The carbon black feedstock can consist of the renewable carbon black feedstock.

The carbon black feedstock of the present invention may comprise tall oil pitch in an amount of greater than or equal to 5 wt.-%, such as greater than or equal to 10 wt.-%, or greater than or equal to 15 wt.-%, or greater than or equal to 20 wt.-%, or greater than or equal to 25 wt.-%, or greater than or equal to 30 wt.-%, or greater than or equal to 35 wt.-%, greater than or equal to 40 wt.-%, or greater than or equal to 45 wt.-%, or greater than or equal to 50 wt.-%, or greater than or equal to 55 wt.-%, or greater than or equal to 60 wt.-%, or greater than or equal to 65 wt.-%, or greater than or equal to 70 wt.-%, or greater than or equal to 75 wt.-%, or greater than or equal to 80 wt.-%, or greater than or equal to 85 wt.-%, or greater than or equal to 90 wt.-%, gor reater than or equal to 95 wt.-%, the weight percent being based on the total weight of the carbon black feedstock. The carbon black feedstock may comprise tall oil pitch in an amount greater than or equal to 10 wt.-%, preferably greater than or equal to 15 wt.-%, particularly preferably greater than or equal to 25 wt.-%, more preferably greater than or equal to 50 wt.-%, even more preferably greater than or equal to 85 wt.-%, most preferably greater than or equal to 95 wt.-%, the weight percent being based on the total weight of the carbon black feedstock. The carbon black feedstock can consist of tall oil pitch.

The renewable carbon black feedstock of the present invention may comprise tall oil pitch in an amount of greater than or equal to 5 wt.-%, such as greater than or equal to 10 wt.-%, or greater than or equal to 15 wt.-%, or greater than or equal to 20 wt.-%, or greater than or equal to 25 wt.-%, or greater than or equal to 30 wt.-%, or greater than or equal to 35 wt.-%, or greater than or equal to 40 wt.-%, or greater than or equal to 45 wt.-%, or greater than or equal to 50 wt.-%, or greater than or equal to 55 wt.-%, or greater than or equal to 60 wt.-%, or greater than or equal to 65 wt.-%, or greater than or equal to 70 wt.-%, or greater than or equal to 75 wt.-%, or greater than or equal to 80 wt.-%, or greater than or equal to 85 wt.-%, or greater than or equal to 90 wt.-%, or greater than or equal to 95 wt.-%, the weight percent being based on the total weight of the renewable carbon black feedstock. The renewable carbon black feedstock may comprise tall oil pitch in an amount greater than or equal to 10 wt.-%, preferably greater than or equal to 15 wt.-%, particularly preferably greater than or equal to 25 wt.-%, more preferably greater than or equal to 50 wt.-%, even more preferably greater than or equal to 85 wt.-%, most preferably greater than or equal to 95 wt.-%, the weight percent being based on the total weight of the renewable carbon black feedstock. The renewable carbon black feedstock may consist of tall oil pitch.

The carbon black of the present invention can have a pMC (percent of modern carbon) of 1% or more, determined according to ASTM D6866-20 Methode B (AMS), such as 2% or more, or 5% or more, or 7% or more, or 10% or more, or 12% or more, or 15% or more, or 17% or more, or 20% or more, or 22% or more, or 25% or more, or 27% or more, or 30% or more, or 32% or more, or 35% or more, or 37% or more, or 40% or more, or 42% or more, or 45% or more, or 47% or more, or 50% or more, or 52% or more, or 55% or more, or 57% or more, or 60% or more, or 62% or more, 65% or more, or 67% or more, or 70% or more, or 72% or more, or 75% or more, or 77% or more, or 80% or more, or 82% or more, or 85% or more, or 87% or more, or 90% or more, or 92% or more, or 95% or more, or 97% or more, or 99% or more. For each sample, a ratio of ¹⁴C/¹³C is calculated and compared to measurements made on Oxalic Acid Il standard (NIST-4990C). The measured values (pMC) are corrected by d13C measured using an isotope ratio mass spectrometer (IRMS). The carbon black of the present invention can have a pMC (percent of modern carbon) of 5% or more, determined according to ASTM D6866-20 Methode B (AMS), preferably of 10% or more, particularly preferably of 15% or more, more preferably of 50% or more, even more preferably of 85% or more, most preferably of 90% or moreThe carbon black of the present invention can have a pMC (percent of modern carbon) of 100%, determined according to ASTM D6866-20 Methode B (AMS).

According to the present invention, the carbon black can be a plasma black, a gas black, a channel black, a thermal black, a lamp black or a furnace black, preferably a furnace black.

According to the present invention, the carbon black has an oil absorption number (OAN) measured according to ASTM D2414-19 of equal to or less than 80 mL/100 g. For example, the carbon black may have an OAN measured according to ASTM D2414-19 of equal to or less than 70 mL/100 g, such as of equal to or less than 60 mL/100 g, or of equal to or less than 50 mL/100 g, or of equal to or less than 45 mL/100 g, or of equal to or less than 40 mL/100 g, or of equal to or less than 37 mL/100 g. The carbon black may have an OAN measured according to ASTM D2414-19 of 19 mL/100 g or more, such as 23 mL/100 g or more, or 25 mL/100 g or more. The carbon black according to the present invention can have an OAN in a range between any of the recited lower and upper limit values. The carbon black according to the present invention may have an OAN measured according to ASTM D2414-19 in a range of from 19 to 80 mL/100 g, preferably from 19 to 70 mL/100 g, particularly preferably from 23 to 60 mL/100g, more preferably from 23 to 50 mL/100 g, even more preferably from 25 to 40 mL/100 g, most preferably from 25 to 37 mL/100 g.

The carbon black according to the invention can be further characterized by a BET surface area, a statistic thickness surface area (STSA), a tint strength, a transmittance value at 425 nm, a content of polycyclic aromatic hydrocarbons, a content of toluene-soluble constituents and/or a sulfur content as set forth more specifically in the following. The carbon black of the present invention may have at least one of the following properties, i.e., a BET surface area, a statistic thickness surface area (STSA), a tint strength, a transmittance value at 425 nm, a content of polycyclic aromatic hydrocarbons, a content of toluene-soluble constituents and a sulfur content, preferably two or more or all of the following properties.

The carbon black according to the invention can have a BET surface area of 15 m²/g or more, such as 20 m²/g or more, or 25 m²/g or more, or 30 m²/g or more, or 40 m2/g or more, or 50 m²/g or more, or 60 m²/g or more, or 65 m²/g or more. The carbon black according to the invention can have a BET surface area of 400 m²/g or less, such as 350 m²/g or less, or 300 m²/g or less, or 250 m²/g or less, or 200 m²/g or less, or 180 m²/g or less. The carbon black according to the present invention can have a BET surface area in a range between any of the recited lower and upper limit values. The BET surface area of the carbon black of the present invention can for example be in a range of 15 to 400 m²/g, preferably from 30 to 350 m²/g , particularly preferably from 40 to 300 m²/g, more preferably from 50 to 250 m²/g , even more preferably from 60 to 200 m²/g, most preferably from 65 to 180 m²/g. The BET surface area can be determined according to ASTM D6556-19a.

The carbon black according to the invention can have a statistical thickness surface area (STSA) of 15 m²/g or more, such as 20 m²/g or more, or 25 m²/g or more, or 30 m²/g or more, or 40 m²/g or more, or 50 m²/g or more, or 60 m²/g or more, or 65 m²/g or more. The carbon black according to the invention can have a STSA of up to 300 m²/g , such as 250 m²/g or less, or 220 m²/g or less, or 200 m²/g or less, 180 m²/g or less, or 150 m²/g or less. The carbon black according to the invention can have a STSA in a range between any of the recited lower and upper limit values. The carbon black of the present invention can have a STSA in a range of from 15 to 300 m²/g, preferably from 30 to 250 m²/g, more preferably from 50 to 200 m²/g, even more preferably from 60 to 180 m²/g, most preferably from 65 to 150 m²/g. The statistical thickness surface area (STSA) can be determined according to ASTM D6556-19a.

The carbon black according to the invention can have a tint strength of 20% or more, such as 30% or more, or 40% or more, or 50% or more, or 60% or more, or 70% or more, or 80% or more, or 90% or more. The carbon black according to the invention can have a tint strength of 200% or less, such as 180% or less, or 150% or less, or 120% or less, or 110% or less. The carbon black according to the present invention can have a tint strength in a range between any of the recited lower and upper limit values. The carbon black of the present invention can have a tint strength in a range of from 20 to 200%, preferably from 60 to 150%, more preferably from 80 to 120%, even more preferably from 90 to 110%. The tint strength can be determined according to ASTM D3265-19b.

The carbon black according to the invention can have a transmittance value at 425 nm of 50% or more, such as 70% or more, or 80% or more, or 90% or more, or 95% or more. The carbon black according to the invention can have a transmittance value at 425 nm of 100% or less. The carbon black according to the present invention can have a transmittance value at 425 nm in a range between any of the recited lower and upper limit values. The carbon black of the present invention can have a transmittance value at 425 nm in a range of from 50 to 100%, preferably from 70 to 100%, more preferably from 80 to 100%, even more preferably from 90 to 100%, most preferably from 95 to 100%. The transmittance value at 425 nm can be determined according to ASTM D1618-18.

The carbon black according to the invention may have a content of polycyclic aromatic hydrocarbons of less than 10 ppm, preferably less than 5 ppm, particularly less than 1 ppm, more preferably less than 0.5 ppm, even more preferably less than 0.4 ppm, most preferably less than 0.2 ppm. The carbon black of the present invention may have a content of polycyclic aromatic hydrocarbons of in a range of from 0.001 to 10 ppm, preferably from 0.001 to 5 ppm, particularly preferably from 0.001 to 1 pm, more preferably from 0.001 to 0.5 ppm, even more preferably from 0.001 to 0.4 ppm, most preferably of 0.001 to 0.2 ppm. The content of polycyclic aromatic hydrocarbons can be measured according to FDA methods No. 63 (22 FDA PAH). The content of the polycyclic aromatic hydrocarbons of the 22 PAH method is calculated from the sum of the compounds including naphthalene, acenaphthalene, acenaphthene, fluorene, phenanthrene, anthracene, fluoranthene, pyrene, benzo(ghi)fluoranthene, cyclopenta(cd)pyrene, chrysene, benzo(e)pyrene, perylene, benzo(ghi)perylene, anthanthrene, coronene, benz(a)anthracene, benzo(k)fluoranthene, dibenz(ah)anthracene, benzo(a)pyrene, indeno(1,2,3-cd)pyrene, benzo(b)fluoranthene and benzo(j)fluoranthene, where benzo(b)fluoranthene and benzo(j)fluoranthene are counted as one. The FDA methods No. 63 (22 FDA PAH) involves extracting the carbon black by means of a Soxleth apparatus, performing the detection by means of gas chromatography and conducting the calculation taking account of the aforementioned 22 PAHs (“Determination of PAH content of carbon black”, Cabot Corporation, Docket 95F-01631, 8. July 1994, laid down by the American Food and Drug Administration (FDA), Code of Federal Regulations, Title 21, Vol. 3, Part 170-199; § Colorants for Polymers, High purity furnace Blacks, Page 372-376; CITE 21CFR178.3297).

The carbon black according to the invention may have a content of toluene-soluble constituents of 0.20% or less, such as 0.15% or less, or 0.10% or less. The carbon black according to the invention can have a content of toluene-soluble constituents of 0.01% or more, such as 0.02% or more. The carbon black according to the present invention can have a content of toluene-soluble constituents in a range between any of the recited lower and upper limit values. The carbon black of the present invention may have a content of toluene-soluble constituents in a range of from 0.01% to 0.20%, preferably from 0.02% to 0.10%. The content of toluene-soluble constituents can be measured following the procedure described in ASTM D4527-04. Deviating from the conditions set forth in ASTM D4527-04, an extraction time of 8 hours and a cyclic time of 6 to 7 min is applied. Furthermore, the sample is dried at atmospheric pressure (1.013 105 Pa) at 70° C. for 12 hours.

The carbon black according to the invention may have a sulfur content of 2.5% or less, such as 2.0% or less, or 1.5% or less. The carbon black of the present invention may have a sulfur content in a range of from 0% to 2.5%, preferably from 0% to 2.0%, more preferably from 0 to 1.5%. The content of sulfur content can be measured according to ASTM D1619-20.

According to the present invention, the carbon black can be oxidized. Herein, the term “oxidized” means that the carbon black has been subjected to an oxidative treatment and thus comprises oxygen-containing functional groups. Oxidized carbon blacks, unlike non-oxidized carbon blacks, thus generally have a notable oxygen content and have oxygen-containing functional groups, which can be exemplified, but are not limited to, quinone, carboxyl, phenol, lactol, lactone, anhydride and ketone groups. For example, oxidized carbon blacks can have an oxygen content of 0.5 wt.-% or more, such as 1 wt.-% or more, or 2 wt.-% or more, based on the total weight of the oxidized carbon black material. Typically, the oxygen content does not exceed 20 wt.-%, based on the total weight of the oxidized carbon black material. For example, the oxidized carbon black can contain from 0.5 wt.-% to 20 wt.-%, or from 1 wt.-% to 15 wt.-%, or from 2 wt.-% to 10 wt.-%, or from 2 wt.-% to 5 wt.-% of oxygen, based on the total weight of the oxidized carbon black material.

Oxidized carbon blacks can be produced by various methods known in the art such as for example disclosed in U.S. Pat. Nos. 6,120,594 and 6,471,933. Suitable methods include oxidation of a carbon black material with an oxidizing agent as for example peroxides such as hydrogen peroxide, persulfates such as sodium and potassium persulfates, hypohalites such as sodium hypochlorite, ozone or oxygen gas, transition metal-containing oxidants such as permanganate salts, osmium tetroxide, chromium oxides, ceric ammonium nitrates or oxidizing acids such as nitric acid or perchloric acid, and mixtures or combinations thereof.

According to the present invention, the carbon black can further be functionalized. Carbon blacks can be functionalized by treatment using functionalizing agents. Functionalized carbon blacks can for example be obtained by treating an oxidized carbon black with a sulfur-containing primary or secondary amine or a salt thereof as described in WO 2021/001156 A1. Accordingly, the treatment leads to a chemical change of the oxidized carbon black by the sulfur-containing amine imparting functionalities derived from the treatment agent such as sulfur-containing moieties and/or amine groups to the oxidized carbon black.

The invention also relates to a process for producing the carbon black according to the present invention through thermal oxidative pyrolysis or cleavage of a carbon black feedstock in a reactor. The process of the invention comprises feeding an O₂-containing gas stream and a fuel stream comprising combustible material to the reactor. The combustible material is subjected to combustion in a combustion step to provide a combustion gas stream, wherein the O₂-containing gas stream and the fuel stream comprising combustible material are provided for the combustion step in amounts corresponding to a k factor in the range of from 0.5 to 1.0. The carbon black feedstock is contacted with the combustion gas stream in a reaction step to form carbon black and the carbon black formation reaction is terminated in a terminating step. According to the present invention, the k factor is the ratio of O₂ theoretically necessary for stoichiometric combustion of all combustible material in the combustion step to the total O₂ provided for the combustion step. Accordingly, a k factor of 1 signifies a stoichiometric combustion. In the case of excess O₂, the k factor is less than 1.

According to the present invention, the carbon black feedstock comprises a renewable carbon black feedstock. Suitable renewable carbon black feedstocks and suitable ranges of the renewable carbon black feedstocks are as described above.

The fuel stream according to the present invention can be any material that is combustible. Preferably the fuel stream comprises liquid and/or gaseous hydrocarbons, hydrogen, carbon monoxide or mixtures thereof. The fuel stream may comprise at least 50 wt.-%, such as at least 70 wt.-%, such as at least 90 wt.-%, such as at least 95 wt.-% of hydrocarbons. Suitable examples for fuel stream include, but are not limited to, natural gas, coal gas, petroleum gas, petroleum type liquid fuels such as heavy oil, or coil derived liquid fuels such as creosote oil, fuel oil, wash oil, anthracene oil and crude coal tar. Preferably, the fuel stream comprises natural gas. Alternatively, the fuel stream may comprise plasma gas. The fuel stream is subjected in the combustion step to combustion in order to provide a combustion gas stream.

As O₂-containing gas stream any gas stream can be used that comprises oxygen gas. Suitable examples of O₂-containing gas stream include, but are not limited to, air, oxygen-reduced air and oxygen-enriched air.

The combustion may be performed at a temperature in a range of from 1,000 to 2,700° C., preferably from 1,200 to 2,200° C., more preferably from 1,300 to 2,000° C.

According to the invention the k factor may further be in the range of from 0.6 to 1.0, preferably from 0.7 to 1.0, more preferably from 0.75 to 1.0, even more preferably from 0.8 to 1.0. The person skilled in the art will appreciate that the k factor can be easily calculated from the content and type of combustible material and the O2 content in the feed streams and their respective flow rate. Renewable carbon black feedstocks typically provide low carbon black yields, especially compared to conventional carbon black feedstocks. Surprisingly, it was found that the improvement in carbon black yield was more pronounced with the renewable feedstocks compared to conventional fossil-based feedstocks. In addition, k factors in the herein described ranges may contribute to lowering the OAN of the resulting carbon blacks.

In the process of the invention, the combustion gas generated in the combustion step is contacted in the reaction step with the carbon black feedstock of the present invention. In the reaction step pyrolysis or cleavage of the carbon black feedstock takes place and carbon black as well as tail gas is formed.

The carbon black formation may be performed at a temperature in a range of from 1,000 to 2,000° C., preferably from 1,100 to 1,900° C., more preferably from 1,200 to 1,800° C.

According to the invention, the carbon black formation is terminated in the termination step. Termination of the carbon black formation can be achieved by any means known to the person skilled in the art, such as cooling by direct or indirect heat exchange, for example by using a quench boiler and/or by quenching. Typically, quenching is achieved by injecting a suitable quench liquid, such as water. Preferably, the carbon black formation is terminated by water quenching.

In the process according to the invention, carbon black formation may be terminated when an acetylene amount of less than 0.8 mol.-% based on the total dry tail gas stream, preferably less than 0.6 mol.-%, more preferably less than 0.5 mol.-%, even more preferably less than 0.2 mol.-% is reached during carbon black formation. The acetylene amount can be determined by gas chromatography. Terminating the carbon black formation at low acetylene amounts in the tail gas can contribute to low PAH concentrations and low contents of toluene-soluble constituents of the resulting carbon blacks.

According to the present invention, the process may be carried out in a furnace-black reactor including producing a combustion gas stream in the combustion zone, and passing the combustion gas from the combustion zone through the reaction zone into the terminating zone, injecting the carbon black feedstock into the combustion gas in the reaction zone to form carbon black and terminating carbon black formation in the termination zone by lowering the temperature by quenching and/or by using a quench boiler. The furnace black reactor of the present invention may have, along the reactor axis, a combustion zone, a reaction zone and a termination zone. Suitable furnace-black reactor are described in, e.g., EP 2479223 A1 or EP 1233042 A2.

The invention also relates to use of the carbon black according to the invention as reinforcing filler or additive, UV stabilizer, conductive carbon black or pigment.

Furthermore, the present invention relates to use of the carbon black according to the present invention in rubber, plastics, inks such as printing inks, inkjet inks or other inks, toners, lacquers, coatings, papers or black matrix applications. Black matrix application according to the present invention may include display devices.

The carbon black of the present invention can be used preferably for applications in materials with food contact, skin contact, for toys, for packaging printing inks, for toner applications or inkjet inks.

The invention further relates to a rubber composition. The rubber composition comprises at least one rubber material and at least one carbon black of the present invention.

The terms “rubber material” and “rubber” may be used interchangeably throughout this description unless otherwise stated. Rubbers that can be used according to the present invention include those containing olefinic unsaturation, i.e., diene-based rubber materials, as well as non-diene-based rubber materials. The term “diene-based rubber materials” is intended to include both natural and synthetic rubbers or mixtures thereof. According to the present invention the rubber material may comprise natural rubber and/or synthetic rubber such as styrene-butadiene rubber such as emulsion-styrene-butadiene rubber (ESBR) and solution-styrene-butadiene rubber (SSBR), polybutadiene, polyisoprene, ethylene-propylene-diene rubber (EPDM), ethylene-propylene rubber (EPM), butyl rubber, halogenated butyl rubber, chlorinated polyethylene, chlorosulfonated polyethylene, acrylonitrile-butadiene rubber, hydrogenated acrylonitrile-butadiene rubber, polychloroprene, acrylate rubber, ethylene-vinylacetate rubber, ethylene-acrylic rubber, epichlorohydrin rubber, silicone rubber, fluorosilicone rubber, fluorocarbon rubber or a mixture or combination of any of the foregoing.

Natural rubber can be used in its raw form and in various processed forms conventionally known in the art of rubber processing. Natural rubber can for example be obtained from rubber trees (Helvea brasiliensis), guayule, and dandelion.

According to the invention, the synthetic rubber can also be obtained from a renewable source material. For example, polybutadiene can be produced from alcohol obtained through fermentation of plant biomass. Suitable preparation of alcohol obtained through fermentation and preparation of polybutadiene from such alcohol is described in EP 2 868 697 A1.

The rubber composition may comprise the carbon black of the invention in an amount of 3 to 200 phr, such as 5 to 190 phr, or 10 to 150 phr. The unit phr means part by weight per 100 parts by weight of rubber.

The rubber composition comprises a carbon black of the present invention preferably having at least one, preferably all of the following properties being a STSA determined according to ASTM D6556-19a in the range of from 15 to 200 m²/g and a transmittance value at 425 nm determined according to ASTM 1618-18 in a range of 80 to 100%.

The rubber composition may further comprise a conventional carbon black including oxidized carbon black and functionalized carbon blacks. Conventional carbon blacks are typically produced from oil, coal, or other fossil-fuel derived feedstock.

The invention further relates to a plastic composition. The plastic composition comprises at least one plastic material and at least one carbon black of the present invention.

The at least one plastic material may comprise a thermoplastic polymer, a thermosetting polymer, a thermoplastic elastomer, preferably low and high density polyethylene and polypropylene, polyvinyl chloride, melamine-formaldehyde resin, phenolic resin, epoxy resin, polyamide, polyester, polyoxymethylene, polymethyl methacrylate, polycarbonate, polystyrene, polyurethane, polyphenylene oxide, polysiloxane, polyacryloamide, polyaryletherketone, polysulfone, polyetherimide, acrylonitrile styrene acrylate or acrylonitrile butadiene styrene polymer and mixtures or co-polymers of any of the foregoing.

The plastic composition comprises a carbon black of the present invention preferably having at least one, preferably two or more or all of the following properties being an OAN determined according ASTM D2414-19 in a range of from 45 to 80, more preferably from 50 to 70; a STSA determined according to ASTM D6556-19a in a range of from 15 to 200; a tint strength determined according to ASTM D1618-18 in a range of from 20 to 160, more preferably from 20 to 150; and a content of toluene-soluble constituents following the procedure in ASTM D4527-04 of less than 0.1%, such as 0.01% to 0.10%. Deviating from the conditions set forth in ASTM D4527-04, an extraction time of 8 hours and a cyclic time of 6 to 7 min is applied. Furthermore, the sample is dried at atmospheric pressure (1.013.105 Pa) at 70° C.for 12 hours. Such low contents of toluene- soluble constituents are particularly suitable for food contact applications.

The plastic composition according to the invention may comprise 40 to 99.9 wt.-%, preferably 60 to 99 wt.-%, more preferably 80 to 98 wt.-% of the at least one plastic material, based to the total weight of plastic composition. The plastic composition may comprise 0.1 to 60 wt.-%, preferably 1.0 to 20 wt.-%, more preferably 1.5 to 3% of the carbon black of the invention, based on the total weight of the plastic composition.

The plastic composition may further comprise a conventional carbon black including oxidized carbon black and functionalized carbon blacks.

The invention further relates to an ink composition. The ink composition comprises a liquid carrier material and at least one carbon black of the present invention.

According to the present invention, the liquid carrier material may comprise water and/or an organic solvent. An organic solvent can comprise alcohols, ketones, esters, aliphatic or aromatic hydrocarbons or mixtures thereof.

The ink composition comprises a carbon black of the present invention preferably having at least one, preferably all of the following properties being an OAN measured according to ASTM D2414-19 in a range of from 19 to 50 mL/100 g, more preferably from 23 to 45 mL/100 g, even more preferably from 25 to 40 mL/100 g and a STSA determined according to ASTM D6556-19a in a range of from 60 to 150 m²/g.

The ink composition according to the present invention may comprise 5 to 95 wt.-%, preferably 30 to 80 wt.-% of a liquid carrier material, based on the total weight to the ink composition. The ink composition according to the present invention may comprise 0.1 to 20 wt.-%, preferably 0.5 to 10 wt.%, more preferably 1 to 5 wt.-% of the carbon black of the present invention, based on the total weight of the ink composition. Liquid packaging printing inks preferably comprise 5 to 15 wt.-%, preferably 8 to 12 wt.-% of the carbon black of the present invention, based on the total weight of the ink composition. Inkjet inks preferably comprise 0.5 to 7 wt.-%, preferably 1 to 5 wt.-% of the carbon black of the present invention and offset inks may comprise up to 20 wt.-%, preferably 0.1 to 20 wt.-% of the carbon black of the present invention, the weight percentages being based on the total weight of the ink composition.

According to the invention, the ink composition may further comprise a binder. A binder generally functions primarily to increase adhesion of the pigment, e.g., of the carbon black, to a substrate, and also often acts as a dispersing medium and carrier. Suitable examples of a binder may include, but are not limited to, nitrocellulose, polyurethane resins, polyamide resins, polyvinyl chloride resins, alkyd resins, polyester resins, epoxy resins, casein, acrylate based dispersions, latex dispersions, and tree resins, such as gum arabic.

The ink composition may further comprise a conventional carbon black including oxidized carbon black and functionalized carbon blacks.

The present invention further relates to use of the ink composition of the present invention for printing and coating applications, preferably for print media and packaging, more preferably for food packaging.

The invention further relates to a black matrix composition comprising at least one carbon black of the present invention. The black matrix composition comprises a carbon black of the present invention preferably having at least one, preferably all of the following properties being an OAN measured according to ASTM D2414-19 of less than 37 mL/100 g and a STSA determined according to ASTM D6556-19a in a range of from 60 to 150 m²/g. Preferably, the black matrix composition comprises a carbon black of the present invention, which is oxidized and/or functionalized as described above.

The black matrix composition may further comprise a conventional carbon black including oxidized carbon black and functionalized carbon blacks

Furthermore, the present invention relates to a coating composition comprising at least one carbon black of the present invention. According to the present invention, coating compositions can be paints or finishes. The coating compositions of the present invention may comprise solvents and resins. The solvent may comprise water and/or an organic solvent. An organic solvent can comprise alcohols, ketones, esters, aliphatic or aromatic hydrocarbons or mixtures thereof. Suitable known coating materials and additives are disclosed in U.S. Pat, No. 5,051,464. The carbon black of the present invention, either as a predispersion or as a solid, can be incorporated into a coating composition using standard techniques. The coating composition comprises a carbon black of the present invention preferably having at least one, preferably all of the following properties, being an OAN measured according to ASTM D2414-19 in a range of from 19 to 50 mL/100 g, more preferably from 23 to 45 mL/100 g, even more preferably from 25 to 40 mL/100 g and a STSA determined according to ASTM D6556-19a in a range of 60 to 150 m²/g.

The coating composition may further comprise a conventional carbon black including oxidized carbon black and functionalized carbon blacks.

The present invention further relates to use of the coating composition of the invention for toys and articles intended for use in contact with food or skin.

Unless otherwise indicated, percentages should be assumed to be wt.-%.

### EXAMPLES

The invention will now be further illustrated by the following Examples. All parts and percentages mentioned herein are based on weight, unless indicated otherwise.

### Carbon black production (Example 1)

A furnace carbon black reactor was used to produce a carbon black according to the present invention. Tall Oil1 from UCY Energy (Germany) being a tall oil pitch based fuel was used as the carbon black feedstock

The carbon black reactor had a combustion chamber in which the combustion gas for the pyrolysis of the carbon black feedstock is produced through combustion of natural gas with introduction of atmospheric oxygen at a temperature of about 2,000° C. A k factor of 0.85 is adjusted. The tall oil pitch was injected in a choke after the combustion chamber in the reaction chamber to form carbon black. In the termination zone the formation of carbon black is terminated by using water quench in combination with an air quench. The termination step was performed, when an acetylene amount of 0.014 mol.-%, based on the total dry tail gas stream, is reached. The acetylene amount was measured by gas chromatography using INFICON 3000 Micro GC available from Inficon Holding AG (Schweiz). For the calibration of the GC for quantitative analysis DIN 51898-1 was used.

Table 1 lists the reactor parameters for producing carbon blacks according to the invention.

| Reactor parameter [unit] | Choke diameter: 144 mm |
|---|---|
| | Tunnel diameter: 875 mm |
| Combustion stream [Nm³/h] | 2600 |
| Combustion stream temperature [° C.] | 705 |
| Fuel (natural gas) [Nm³/h] | 227 |
| Carbon black feedstock [kg/h] | 475 |
| Temperature of carbon black feedstock [° C.] | 98 |
| k factor [%] | 85 |

### Effect of k Factor

For the use of renewable carbon black feedstock, an increased yield improvement compared to the use of conventional carbon black feedstock is found depending on the k-factor. The yield is defined according to formula 1.

$$\frac{m ( carbon black )}{m ( carbon black feedstock )} \cdot 100 \% \qquad ( 1 )$$

The yield obtained at a k factor of 0.6 and a k factor of 0.9 were determined for the use of tall oil pitch (Tall Oil1 from UCY Energy (Germany)) and for the use of a conventional fossil-based carbon black feedstock, namely a coal tar distillate (R43 from RAIN Carbon Germany GmbH (Castrop-Rauxel)) and normalized to the yield obtained at the k factor of 0.6 (Table 3).

TABLE 3
Normalized yields

Normalized yield

| k factor | Tall oil pitch | Coal tar distillate |
|---|---|---|
| 0.6 | 1 | 1 |
| 0.9 | 3.5 | 1.2 |

The yield using renewable carbon black feedstock is low compared to the yield using conventional fossil-based carbon black feedstock. However, when the k factor is increased from 0.6 to 0.9, the yield surprisingly increases by a factor of 3.5 when a renewable carbon black feedstock (tall oil pitch) is used, while the yield is only increased by a factor of 1.2 when the conventional feedstock (coal tar distillate) is used.

### Carbon Black Mmaterials

The following carbon black materials are carbon blacks obtained using conventional feedstock:
PRINTEX® 35: Furnace black with an STSA of about 62 m²/g and an OAN of about 42 mL/100 g, commercially available from Orion Engineered Carbons GmbH

PRINTEX® 25: Furnace black with an STSA of about 49 m²/g and an OAN of about 45 mL/100 g, commercially available from Orion Engineered Carbons GmbH

The properties of the carbon blacks are determined in accordance with the following standards (Table 3) and are listed in Table 4.

TABLE 3
Standards for measuring the properties of the carbon blacks

| Property | Standard |
|---|---|
| OAN | ASTM D2414-19 |
| BET/STSA | ASTM D6556-19a |
| Tint strength | ASTM D3265-19b |
| Sulfur content | ASTM D1619-20 |
| Content of toluene- | ASTM D4527-04 |
| soluble constituents | |
| Content of PAHs | FDA method No. 63 (22 FDA PAH) |

Deviating from the conditions set forth in ASTM D4527-04, an extraction time of 8 hours and a cyclic time of 6 to 7 min is applied. Furthermore, the sample is dried at atmospheric pressure (1.013:105 Pa) at 70° C.for 12 hours.

TABLE 4
Properties of carbon blacks

| | Example 1 | PRINTEX ® 35 | PRINTEX ® 25 |
|---|---|---|---|
| OAN | 33.4 | 42 | 45 |
| STSA | 70.2 | 62 | 49 |
| BET | 69.2 | 60 | 47 |
| Tint strength | 97.5 | 100 | 89 |
| Sulfur content | <2.0 | <1.0 | <1.0 |
| Content of toluene- | 0.02-0.03 | <0.1 | <0.1 |
| soluble constituents | | | |
| Content of PAHs | <10 ppm | <10 ppm | <20 ppm |

Example 1 shows very low OAN which is specifically desirable in ink compositions and coating compositions. Further, low concentrations of polyaromatic hydrocarbons (PAHs) as well as low levels of toluene and sulfur extractables contents are obtained for the carbon black obtained using a renewable carbon black feedstock (Example 1). This is beneficial for use of carbon blacks in articles intended to come into contact with food or the skin, such as in food and drinking water applications, as well as toys.

Use of tall oil pitch as a renewable carbon black feedstock can improve the CO₂ balance.

1. A carbon black having an oil absorption number (OAN) measured according to ASTM D2414-19 of equal to or less than 80 mL/100 g, wherein the carbon black is obtained from a carbon black feedstock comprising a renewable carbon black feedstock.

2. The carbon black according to claim 1, wherein the renewable carbon feedstock comprises a plant-based feedstock; and/or wherein the carbon black feedstock comprises solid components and/or liquid components.

3. The carbon black according to claim 1, wherein the renewable carbon black feedstock comprises at least one of wood, grass, cellulose, hemicellulose, lignin, waste material comprising natural rubber and/or synthetic rubber obtained from a renewable source material, black liquor, tall oil, rubber seed oil, tobacco seed oil, castor oil, pongamia oil, crambe oil, neem oil, apricot kernel oil, rice bran oil, cashew nut shell oil, cyperus esculentus oil, cooking oil, distillation residues from biodiesel plants or a mixture or combination of any of the foregoing.

4. The carbon black according to clain 1, wherein the carbon black has at least one of the following properties:
(a) an oil absorption number (OAN) measured according to ASTM D2414-19 of equal or less than 70 mL/100 g;
(b) a BET surface area determined according to ASTM D6556-19a in a range of from 15 to 400 m²/g;
(c) a statistical thickness surface area (STSA) determined according to ASTM D6556-19a in a range of from 15 to 300 m²/g;
(d) a content of polycyclic aromatic hydrocarbons measured according to FDA method No. 63 (22 FDA PAH) of less than 10 ppm;
(e) a content of toluene-soluble constituents in a range of from 0.01% to 0.20%;
(f) a sulfur content according to ASTM D1619-20 in a range of from 0% to 2.5%.

5. A process for producing carbon black through thermal oxidative pyrolysis or cleavage of a carbon black feedstock in a reactor, the process comprising:
feeding an O₂-containing gas stream and a fuel stream comprising combustible material to the reactor;
subjecting the combustible material to combustion in a combustion step to provide a combustion gas stream, wherein the O₂-containing gas stream and the fuel stream comprising combustible material are provided for the combustion step in amounts corresponding to a k factor in the range of from 0.5 to 1.0, wherein the k factor is the ratio of O₂ theoretically necessary for stoichiometric combustion of all combustible material in the combustion step to the total O₂ provided for the combustion step;
contacting the carbon black feedstock with the combustion gas stream in a reaction step to form carbon black; and
terminating the carbon black formation reaction in a terminating step;
wherein the carbon black feedstock comprises a renewable carbon black feedstock.

6. The process according to claim 5, wherein the k factor is in a range of from 0.6 to 1.0; and/or
wherein the carbon black formation is terminated when an acetylene amount of less than 0.8 mol %, based on the total dry tail gas stream, is reached.

7. The process according to claim 5, wherein the reaction is carried out in a furnace-black reactor having along a reactor axis a combustion zone, a reaction zone and a termination zone, including producing a combustion gas stream in the combustion zone, and passing the combustion gas from the combustion zone through the reaction zone into the terminating zone, injecting the carbon black feedstock into the combustion gas in the reaction zone to form carbon black, and terminating carbon black formation in the termination zone by lowering the temperature by quenching and/or by using a quench boiler.

8. An article comprising the carbon black according to claim 1, wherein the article comprises a reinforcing filler or additive, UV stabilizer, conductive carbon black or pigment.

9. An article comprising the carbon black according to claim 1, wherein the article comprises rubber, plastics, inks toners, lacquers, coatings, papers or black matrix applications.

10. A rubber composition, comprising at least one rubber material and at least one carbon black according to claim 1.

11. A plastic composition comprising at least one plastic material and at least one carbon black according to claim 1.

12. An ink composition comprising a liquid carrier material and at least one carbon black according to claim 1.

13. An article comprising an ink composition comprising a liquid carrier material and at least one carbon black according to caim 1, whererin the articl is selected from the group consisting of printed articles and coated article.

14. A coating composition comprising at least one carbon black according to claim 1.

15. An article comprising a coating composition comprising at least one carbon black according to claim 1, wherein the article is selected from the group consisting of toys and articles intended for use in contact with food or skin.
